(19) United States
(12) Patent Application Publication
(10) Pub. No.: US 2013/0324084 A1
(43) Pub. Date: Dec. 5, 2013

(54) SYSTEMS AND METHODS FOR CONSOLIDATING PHONES IN RESTAURANT ENVIRONMENTS

(71) Applicant: YAT WAI EDWIN KWONG, Hong Kong (HK)

(72) Inventor: YAT WAI EDWIN KWONG, Hong Kong (HK)

(21) Appl. No.: 13/487,059

(22) Filed: Jun. 1, 2012

(51) Int. Cl. H04W 4/16; H04W 4/02; H04W 12/06

(52) U.S. Cl. 455/411

(57) ABSTRACT

Systems and methods are provided for consolidating phones in restaurant environments. In one embodiment, a system is provided. The system can be used in a restaurant environment by discouraging users of a dining table to put phones of the users on the dining table, wherein the phone consolidation device is associated with a phone number for calling forwarding and centrally manages the phones of the users of the table.

### FIELD OF THE INVENTION

This invention is generally related to phones used in restaurants. Specifically, this invention allows phones to be consolidated in a centrally managed device, so that the users can enjoy their time at the restaurant without putting their phones on the table. This would be very useful against thefts or stolen phones.

### BACKGROUND OF THE INVENTION

Phones can be easily stolen, especially in public places such as restaurants. Users in such environments are often put their phones on the tables, so that they can handily receive calls in case their phones ring, or that they can easily dial out to others if they want to. These often create several scenarios in which phones may be stolen or lost. For example, one likely scenario is simply forget that the phones are still on the table. When the user is leaving, the user simply fails to take back the phone he or she has put on the table. In another scenario, one user may be talking to another user on the table without alerting that both the users' phones are sitting on the table. In such a case, it is not hard to imagine that a third person or a stronger may take this opportunity to take away the phones silently. When this happens, there may be a way to monitor and alert such events to make sure such events can be controlled and prevented in advance. Also, another need in view of the above situation is that the users sitting on a table are not required to take out the phone when trying to use the phone; also not required to put the phone on the table, as doing so could be very dangerous for stolen by others. On the other hand, one special purpose required is when a phone stolen in a restaurant, there is a further need to display shows all loc of registered phone, to alert showing loc of stolen phones, to erase all content of phone, and to remember all actions performed by intruders. In view of the above challenges existing in the environments, there is a need to address these issues so that phones can be safely used in restaurants or similar environments.

### SUMMARY OF THE INVENTION

According to embodiments of this invention, a central phone consolidation system is provided to be used in a restaurant environment by discouraging users of a dining table to put phones of the users on the dining table, in order to avoid the phones stolen by others. In one embodiment, the consolidation system comprises a phone belonging to a user of a table; a rfid tag included in the phone; a phone consolidation device placed on the table.

Further in the embodiment, the phone consolidation device is associated with a phone number for calling forwarding and centrally manages the phones of the users of the table; a rfid reader included in the phone consolidation device; a GPS receiver contained inside the phone; a touch-based authentication component included in the phone, wherein the touch-based authentication component allows the user to authenticate the user's identity by the user's fingerprints; a touch-based authentication component included in the phone consolidation device, wherein the touch-based authentication component allows the user to authenticate the user's identity by the user's fingerprints; a call forwarding module included in the phone, wherein the call forwarding module is configured to conduct handshaking with the phone consolidation device, wherein the handshaking comprises: receiving information from the phone consolidation device once the user successfully authenticates the user's identity by using the touch-based authentication component included in the phone, the information including the phone number of the phone consolidation device; a display associated with the phone consolidation device, wherein: the single display supports multiple users using phone service at same time, when the multiple users have registered their phones with the phone consolidation device on the table; the display can show all locations of the already registered phones, in order to make sure that the registered phones are still within proximity of the table and are not stolen by others; and the display can be used to alert the users of the already registered phones in case the registered phones are away from the table unexpectedly, in which case the display would allow the users to erase all content of the phones; a processor; and a memory containing instructions that can be executed by the processor.

With further enhancement, a different embodiment may include instructions comprising detecting that the phone is near the phone consolidation device, based on the rfid tag and the rfid reader; performing authentication by requesting the user's authentication on both the phone and the phone consolidation device, in order to register the phone with the phone consolidation device; after authentication, exchanging phone information to conduct handshaking by exchanging phone numbers of the phone and phone consolidation device; after successfully handshaking, alerting to the user that the phone consolidation device is ready for use and relied upon for phone service; allowing the user to use the phone consolidation device to dial out, without relying on the user's phone, wherein the phone directory of the phone has been uploaded to the phone consolidation device from the phone to fascinate dial out; and allowing the user to use the phone consolidation device to receive calls, without relying on the user's phone, wherein the phone directory of the phone has been uploaded to the phone consolidation device from the phone for the user to realize who is the caller.

Another embodiment may arise. After successfully handshaking, alerting to the user that the phone consolidation device is ready for use and relied upon for phone service; allowing the user to use the phone consolidation device to dial out, without relying on the user's phone, wherein the phone directory of the phone has been uploaded to the phone consolidation device from the phone to fascinate dial out; allowing the user to use the phone consolidation device to receive calls, without relying on the user's phone, wherein the phone directory of the phone has been uploaded to the phone consolidation device from the phone for the user to realize who is the caller; providing an update to all users on the table regarding the phones the users have registered, the update includes the locations of the already registered phones, based on the GPS included in the phones; and if the phone is away from the table unexpectedly, allowing the user to erase the content of the phone through the display associated with the phone consolidation device.

Further, the phone directory of the phone has been uploaded to the phone consolidation device from the phone to fascinate dial out by allowing the user to use the phone consolidation device to receive calls, without relying on the user's phone. Here, the phone directory of the phone has been uploaded to the phone consolidation device from the phone for the user to realize who is the caller; providing an update to all users on the table regarding the phones the users have registered, the update includes the locations of the already registered phones, based on the GPS included in the phones; and if the phone is indeed stolen or lost, allowing the user to monitor the actions of the phone through the display associated with the phone consolidation device.

### BRIEF DESCRIPTION OF THE DRAWINGS

FIG. 1 illustrates a centralized phone system, consistent with an embodiment of the present invention.

### DETAILED DESCRIPTION

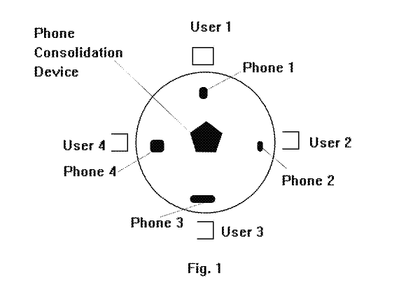

Referring to FIG. 1, a central phone consolidation system is used in a restaurant environment by discouraging users of a dining table to put phones of the users on the dining table. In one implementation, the system comprises a phone belonging to a user of a table; a rfid tag included in the phone; and a phone consolidation device placed on the table. In this example, the phone consolidation device is associated with a phone number for calling forwarding and centrally manages the phones of the users of the table; and a rfid reader is included in the phone consolidation device. The system further includes a GPS receiver contained inside the phone; a touch-based authentication component included in the phone, wherein the touch-based authentication component allows the user to authenticate the user's identity by the user's fingerprints; a touch-based authentication component included in the phone consolidation device, wherein the touch-based authentication component allows the user to authenticate the user's identity by the user's fingerprints; a call forwarding module included in the phone, wherein the call forwarding module is configured to conduct handshaking with the phone consolidation device, wherein the handshaking comprises: receiving information from the phone consolidation device once the user successfully authenticates the user's identity by using the touch-based authentication component included in the phone, the information including the phone number of the phone consolidation device; a display associated with the phone consolidation device.

The single display supports multiple users using phone service at same time, when the multiple users have registered their phones with the phone consolidation device on the table; the display can show all locations of the already registered phones, in order to make sure that the registered phones are still within proximity of the table and are not stolen by others; and the display can be used to alert the users of the already registered phones in case the registered phones are away from the table unexpectedly, in which case the display would allow the users to erase all content of the phones; a processor; and a memory containing instructions that can be executed by the processor, the instructions comprise: detecting that the phone is near the phone consolidation device, based on the rfid tag and the rfid reader; performing authentication by requesting the user's authentication on both the phone and the phone consolidation device, in order to register the phone with the phone consolidation device; after authentication, exchanging phone information to conduct handshaking by exchanging phone numbers of the phone and phone consolidation device.

After successfully handshaking, alerting to the user that the phone consolidation device is ready for use and relied upon for phone service; allowing the user to use the phone consolidation device to dial out, without relying on the user's phone, wherein the phone directory of the phone has been uploaded to the phone consolidation device from the phone to fascinate dial out; and allowing the user to use the phone consolidation device to receive calls, without relying on the user's phone, wherein the phone directory of the phone has been uploaded to the phone consolidation device from the phone for the user to realize who is the caller.

A central phone consolidation system used in a restaurant environment by discouraging users of a dining table to put phones of the users on the dining table, in order to avoid the phones stolen by others, comprising: a phone belonging to a user of a table; a rfid tag included in the phone; a phone consolidation device placed on the table, wherein the phone consolidation device is associated with a phone number for calling forwarding and centrally manages the phones of the users of the table; a rfid reader included in the phone consolidation device; a GPS receiver contained inside the phone; a touch-based authentication component included in the phone, wherein the touch-based authentication component allows the user to authenticate the user's identity by the user's fingerprints; a touch-based authentication component included in the phone consolidation device.

The touch-based authentication component allows the user to authenticate the user's identity by the user's fingerprints; a call forwarding module included in the phone, wherein the call forwarding module is configured to conduct handshaking with the phone consolidation device, wherein the handshaking comprises: receiving information from the phone consolidation device once the user successfully authenticates the user's identity by using the touch-based authentication component included in the phone, the information including the phone number of the phone consolidation device; a display associated with the phone consolidation device, wherein: the single display supports multiple users using phone service at same time, when the multiple users have registered their phones with the phone consolidation device on the table; the display can show all locations of the already registered phones, in order to make sure that the registered phones are still within proximity of the table and are not stolen by others; and the display can be used to alert the users of the already registered phones in case the registered phones are away from the table unexpectedly, in which case the display would allow the users to erase all content of the phones; a processor; and a memory containing instructions that can be executed by the processor, the instructions comprise: detecting that the phone is near the phone consolidation device, based on the rfid tag and the rfid reader; performing authentication by requesting the user's authentication on both the phone and the phone consolidation device, in order to register the phone with the phone consolidation device; after authentication, exchanging phone information to conduct handshaking by exchanging phone numbers of the phone and phone consolidation device; after successfully handshaking, alerting to the user that the phone consolidation device is ready for use and relied upon for phone service; allowing the user to use the phone consolidation device to dial out, without relying on the user's phone.

Alternatively, the phone directory of the phone may has been uploaded to the phone consolidation device from the phone to fascinate dial out; allowing the user to use the phone consolidation device to receive calls, without relying on the user's phone, wherein the phone directory of the phone has been uploaded to the phone consolidation device from the phone for the user to realize who is the caller; providing an update to all users on the table regarding the phones the users have registered, the update includes the locations of the already registered phones, based on the GPS included in the phones; and if the phone is away from the table unexpectedly, allowing the user to erase the content of the phone through the display associated with the phone consolidation device.

In a different implementation, a central phone consolidation system used in a restaurant environment by discouraging users of a dining table to put phones of the users on the dining table, in order to avoid the phones stolen by others, comprising: a phone belonging to a user of a table; a rfid tag included in the phone; a phone consolidation device placed on the table, wherein the phone consolidation device is associated with a phone number for calling forwarding and centrally manages the phones of the users of the table; a rfid reader included in the phone consolidation device; and a GPS receiver contained inside the phone.

A touch-based authentication component can be included in any mobile devices, like a mobile phone or PDA. The touch-based authentication component allows the user to authenticate the user's identity by the user's fingerprints; a touch-based authentication component included in the phone consolidation device, wherein the touch-based authentication component allows the user to authenticate the user's identity by the user's fingerprints; a call forwarding module included in the phone, wherein the call forwarding module is configured to conduct handshaking with the phone consolidation device, wherein the handshaking comprises: receiving information from the phone consolidation device once the user successfully authenticates the user's identity by using the touch-based authentication component included in the phone, the information including the phone number of the phone consolidation device; a display associated with the phone consolidation device, wherein: the single display supports multiple users using phone service at same time, when the multiple users have registered their phones with the phone consolidation device on the table; the display can show all locations of the already registered phones, in order to make sure that the registered phones are still within proximity of the table and are not stolen by others; and the display can be used to alert the users of the already registered phones in case the registered phones are away from the table unexpectedly, in which case the display would allow the users to erase all content of the phones; a processor; and a memory containing instructions that can be executed by the processor, the instructions comprise: detecting that the phone is near the phone consolidation device, based on the rfid tag and the rfid reader; performing authentication by requesting the user's authentication on both the phone and the phone consolidation device, in order to register the phone with the phone consolidation device; after authentication, exchanging phone information to conduct handshaking by exchanging phone numbers of the phone and phone consolidation device; after successfully handshaking, alerting to the user that the phone consolidation device is ready for use and relied upon for phone service; allowing the user to use the phone consolidation device to dial out, without relying on the user's phone, wherein the phone directory of the phone has been uploaded to the phone consolidation device from the phone to fascinate dial out; allowing the user to use the phone consolidation device to receive calls, without relying on the user's phone, wherein the phone directory of the phone has been uploaded to the phone consolidation device from the phone for the user to realize who is the caller; providing an update to all users on the table regarding the phones the users have registered, the update includes the locations of the already registered phones, based on the GPS included in the phones; and if the phone is indeed stolen or lost, allowing the user to monitor the actions of the phone through the display associated with the phone consolidation device.

What is claimed is:

1. A central phone consolidation system used in a restaurant environment by discouraging users of a dining table to put phones of the users on the dining table, in order to avoid the phones stolen by others, comprising:
a phone belonging to a user of a table;
a rfid tag included in the phone;
a phone consolidation device placed on the table, wherein the phone consolidation device is associated with a phone number for calling forwarding and centrally manages the phones of the users of the table;
a rfid reader included in the phone consolidation device;
a GPS receiver contained inside the phone;
a touch-based authentication component included in the phone, wherein the touch-based authentication component allows the user to authenticate the user's identity by the user's fingerprints;
a touch-based authentication component included in the phone consolidation device, wherein the touch-based authentication component allows the user to authenticate the user's identity by the user's fingerprints;
a call forwarding module included in the phone, wherein the call forwarding module is configured to conduct handshaking with the phone consolidation device, wherein the handshaking comprises:
receiving information from the phone consolidation device once the user successfully authenticates the user's identity by using the touch-based authentication component included in the phone, the information including the phone number of the phone consolidation device;
a display associated with the phone consolidation device, wherein:
the single display supports multiple users using phone service at same time, when the multiple users have registered their phones with the phone consolidation device on the table;
the display can show all locations of the already registered phones, in order to make sure that the registered phones are still within proximity of the table and are not stolen by others; and
the display can be used to alert the users of the already registered phones in case the registered phones are away from the table unexpectedly, in which case the display would allow the users to erase all content of the phones;
a processor; and
a memory containing instructions that can be executed by the processor.

2. The system of claim 1, wherein the instructions comprise:
detecting that the phone is near the phone consolidation device, based on the rfid tag and the rfid reader;
performing authentication by requesting the user's authentication on both the phone and the phone consolidation device, in order to register the phone with the phone consolidation device;
after authentication, exchanging phone information to conduct handshaking by exchanging phone numbers of the phone and phone consolidation device;
after successfully handshaking, alerting to the user that the phone consolidation device is ready for use and relied upon for phone service;
allowing the user to use the phone consolidation device to dial out, without relying on the user's phone, wherein the phone directory of the phone has been uploaded to the phone consolidation device from the phone to fascinate dial out; and
allowing the user to use the phone consolidation device to receive calls, without relying on the user's phone, wherein the phone directory of the phone has been uploaded to the phone consolidation device from the phone for the user to realize who is the caller.

3. The system of claim 1, wherein the instructions comprise:
detecting that the phone is near the phone consolidation device, based on the rfid tag and the rfid reader;
performing authentication by requesting the user's authentication on both the phone and the phone consolidation device, in order to register the phone with the phone consolidation device;
after authentication, exchanging phone information to conduct handshaking by exchanging phone numbers of the phone and phone consolidation device;
after successfully handshaking, alerting to the user that the phone consolidation device is ready for use and relied upon for phone service;
allowing the user to use the phone consolidation device to dial out, without relying on the user's phone, wherein the phone directory of the phone has been uploaded to the phone consolidation device from the phone to fascinate dial out;
allowing the user to use the phone consolidation device to receive calls, without relying on the user's phone, wherein the phone directory of the phone has been uploaded to the phone consolidation device from the phone for the user to realize who is the caller;
providing an update to all users on the table regarding the phones the users have registered, the update includes the locations of the already registered phones, based on the GPS included in the phones; and
if the phone is away from the table unexpectedly, allowing the user to erase the content of the phone through the display associated with the phone consolidation device.

4. The system of claim 1, wherein the instructions comprise:
detecting that the phone is near the phone consolidation device, based on the rfid tag and the rfid reader;
performing authentication by requesting the user's authentication on both the phone and the phone consolidation device, in order to register the phone with the phone consolidation device;
after authentication, exchanging phone information to conduct handshaking by exchanging phone numbers of the phone and phone consolidation device;
after successfully handshaking, alerting to the user that the phone consolidation device is ready for use and relied upon for phone service;
allowing the user to use the phone consolidation device to dial out, without relying on the user's phone, wherein the phone directory of the phone has been uploaded to the phone consolidation device from the phone to fascinate dial out;
allowing the user to use the phone consolidation device to receive calls, without relying on the user's phone, wherein the phone directory of the phone has been uploaded to the phone consolidation device from the phone for the user to realize who is the caller;
providing an update to all users on the table regarding the phones the users have registered, the update includes the locations of the already registered phones, based on the GPS included in the phones; and
if the phone is indeed stolen or lost, allowing the user to monitor the actions of the phone through the display associated with the phone consolidation device.

5. A method used in a restaurant environment by discouraging users of a dining table to put phones of the users on the dining table, in order to avoid the phones stolen by others, comprising:
detecting that a phone is near a phone consolidation device, based on a rfid tag and a rfid reader;
performing authentication by requesting a user's authentication on both the phone and the phone consolidation device, in order to register the phone with the phone consolidation device;
after authentication, exchanging phone information to conduct handshaking by exchanging phone numbers of the phone and phone consolidation device;
after successfully handshaking, alerting to the user that the phone consolidation device is ready for use and relied upon for phone service;
allowing the user to use the phone consolidation device to dial out, without relying on the user's phone, wherein a phone directory of the phone has been uploaded to the phone consolidation device from the phone to fascinate dial out; and
allowing the user to use the phone consolidation device to receive calls, without relying on the user's phone, wherein the phone directory of the phone has been uploaded to the phone consolidation device from the phone for the user to realize who is the caller.

6. The method of claim 5, further comprising:
detecting that the phone is near the phone consolidation device, based on the rfid tag and the rfid reader;
performing authentication by requesting the user's authentication on both the phone and the phone consolidation device, in order to register the phone with the phone consolidation device;
after authentication, exchanging phone information to conduct handshaking by exchanging phone numbers of the phone and phone consolidation device;
after successfully handshaking, alerting to the user that the phone consolidation device is ready for use and relied upon for phone service;
allowing the user to use the phone consolidation device to dial out, without relying on the user's phone, wherein the phone directory of the phone has been uploaded to the phone consolidation device from the phone to fascinate dial out;
allowing the user to use the phone consolidation device to receive calls, without relying on the user's phone, wherein the phone directory of the phone has been uploaded to the phone consolidation device from the phone for the user to realize who is the caller;
providing an update to all users on the table regarding the phones the users have registered, the update includes the locations of the already registered phones, based on the GPS included in the phones; and
if the phone is away from the table unexpectedly, allowing the user to erase the content of the phone through the display associated with the phone consolidation device.

7. The method of claim 5, further comprising:
detecting that the phone is near the phone consolidation device, based on the rfid tag and the rfid reader;
performing authentication by requesting the user's authentication on both the phone and the phone consolidation device, in order to register the phone with the phone consolidation device;
after authentication, exchanging phone information to conduct handshaking by exchanging phone numbers of the phone and phone consolidation device;
after successfully handshaking, alerting to the user that the phone consolidation device is ready for use and relied upon for phone service;
allowing the user to use the phone consolidation device to dial out, without relying on the user's phone, wherein the phone directory of the phone has been uploaded to the phone consolidation device from the phone to fascinate dial out;
allowing the user to use the phone consolidation device to receive calls, without relying on the user's phone, wherein the phone directory of the phone has been uploaded to the phone consolidation device from the phone for the user to realize who is the caller;
providing an update to all users on the table regarding the phones the users have registered, the update includes the locations of the already registered phones, based on the GPS included in the phones; and
if the phone is indeed stolen or lost, allowing the user to monitor the actions of the phone through the display associated with the phone consolidation device.
